(19) United States
(12) Patent Application Publication
(10) Pub. No.: US 2013/0330496 A1
(43) Pub. Date: Dec. 12, 2013

(54) COMPOSITE STRUCTURE WITH LOW DENSITY CORE AND COMPOSITE STITCHING REINFORCEMENT

(71) Applicants: Nicholas Joseph Kray, Mason, OH (US); Wendy Wen-Ling Lin, Niskayuna, NY (US); Dong-Jin Shim, Cohoes, NY (US); Ross Spoonire, Albany, NY (US)

(72) Inventors: Nicholas Joseph Kray, Mason, OH (US); Wendy Wen-Ling Lin, Niskayuna, NY (US); Dong-Jin Shim, Cohoes, NY (US); Ross Spoonire, Albany, NY (US)

(73) Assignee: GENERAL ELECTRIC COMPANY, Schenectady, NY (US)

(21) Appl. No.: 13/490,235

(22) Filed: Jun. 6, 2012

(51) Int. Cl. B32B 7/08; B63H 1/26; B32B 38/00

(52) U.S. Cl. 428/71; 428/76; 156/93; 416/223 R

(57) ABSTRACT

A composite structure includes: a core having a pair of opposed exterior surfaces and having a first density; a composite layup surrounding the core, the composite layup comprising a plurality of layers of fibers embedded in a matrix and extending along the exterior surfaces of the core, the composite layup having a second density; and stitching comprising fibers extending through the core and at least a portion of the composite layup.

### BACKGROUND OF THE INVENTION

This invention relates generally to composite structures, and more particularly to composite gas turbine engine fan blades.

Composite wide-chord fan blades are known for use in gas turbine engines. A large engine having all-composite wide chord fan blades offers a significant weight savings over a large engine having fan blades made from metal alloys.

Manufacturers continually strive for even more weight reduction in large turbofan engines, especially in the fan blades which comprise the majority of the fan module's weight. It is known that the weight of static composite structures can be reduced by using a low-density material (such as polymer foam) as a core material sandwiched between composite sheets. However, in a rotating fan blade application, testing and analysis has identified high shear strains induced at the interface between this lightweight core and carbon resulting in delamination, which is unacceptable for a fan blade application.

Accordingly, there is a need for a composite structure incorporating low-density material suitable for use in rotating fan blades.

### BRIEF DESCRIPTION OF THE INVENTION

This need is addressed by the present invention, which provides a composite structure with a low-density core. High-tensile strength stitching is stitched through the core to increase its stiffness and strength.

According to one aspect of the invention, a composite structure includes: a core having a pair of opposed exterior surfaces and having a first density; a composite layup surrounding the core, the composite layup comprising a plurality of layers of fibers embedded in a matrix and extending along the exterior surfaces of the core, the composite layup having a second density; and stitching comprising fibers extending through the core and at least a portion of the composite layup.

According to another aspect of the invention, a method of making a composite structure includes: stitching fibers through both of: a core that includes a pair of opposed exterior surfaces, wherein the core has a first density; and at least a portion of a composite layup that surrounds the core, the composite layup comprising a plurality of layers of fibers extending along the exterior surfaces of the core, the fibers embedded in an uncured resin matrix, wherein the composite layup has a second density; and simultaneously curing the core, the composite layup, and the fibers.

### BRIEF DESCRIPTION OF THE DRAWINGS

The invention may be best understood by reference to the following description taken in conjunction with the accompanying drawing figures in which:

FIG. 1 is a schematic side view of a turbine engine fan blade constructed in accordance with an aspect of the present invention;

FIG. 2 is a view taken along lines 2-2 of FIG. 1; and

FIG. 3 an enlarged view of a portion of FIG. 2.

### DETAILED DESCRIPTION OF THE INVENTION

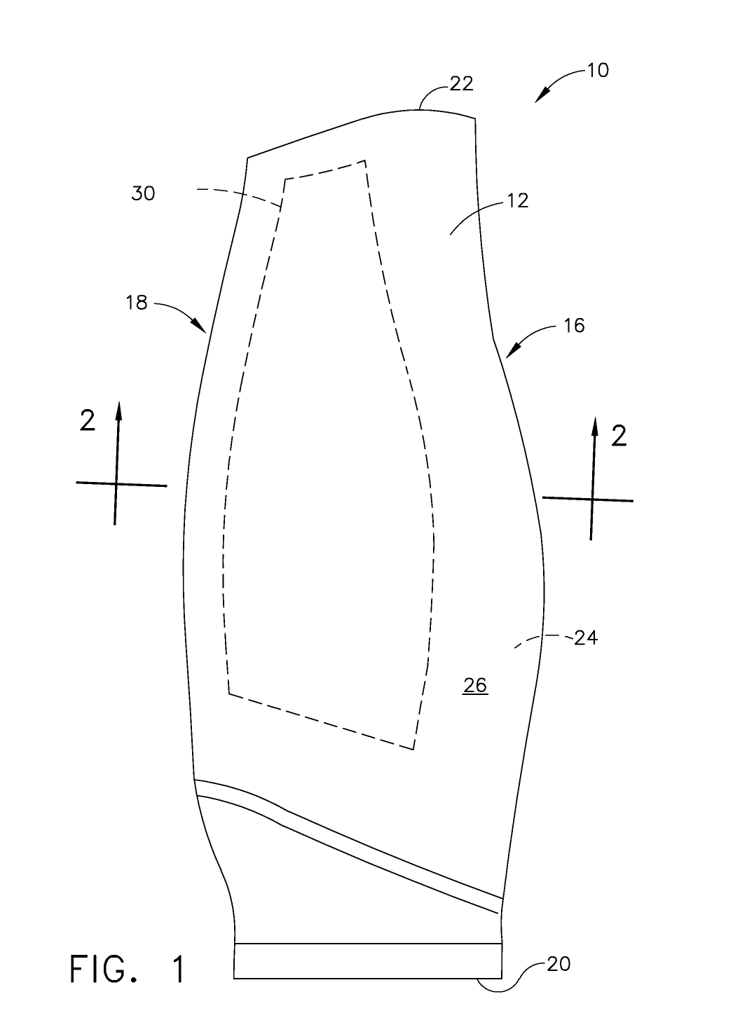

Referring to the drawings wherein identical reference numerals denote the same elements throughout the various views, FIG. 1 illustrates an exemplary composite fan blade 10 for a high bypass ratio turbofan engine (not shown) including a composite airfoil 12 extending in a chordwise direction C from a leading edge 16 to a trailing edge 18. The airfoil 12 extends radially outward in a spanwise direction S from a root 20 to a tip 22. The airfoil 12 has a concave pressure side 24 and a convex suction side 26.

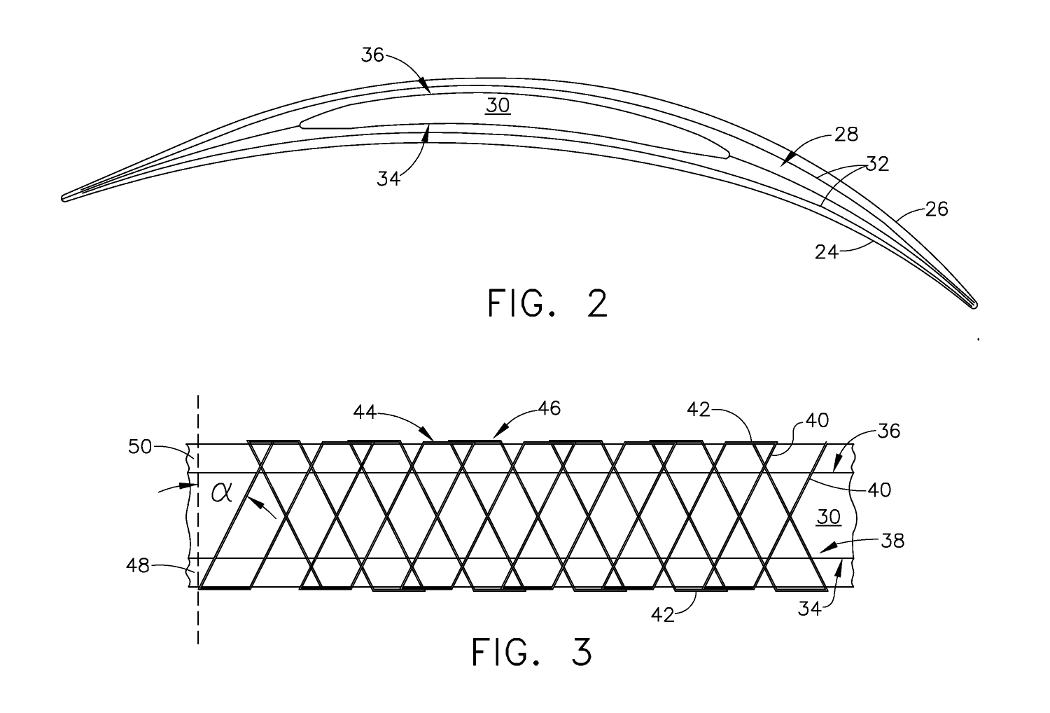

As seen in FIG. 2, the airfoil 12 is constructed from a composite layup 28 with a core 30 disposed therein. The term “composite” refers generally to a material containing a reinforcement such as fibers or particles supported in a binder or matrix material. In the illustrated example the composite layup 28 includes a number of layers or plies 32 embedded in a matrix and oriented substantially parallel to the pressure and suction sides 24 and 26. A nonlimiting example of a suitable material is a carbonaceous (e.g. graphite) fiber embedded in a resin material such as epoxy. These are commercially available as fibers unidirectionally aligned into a tape that is impregnated with a resin. Such “prepreg” tape can be formed into a part shape, and cured via an autoclaving process or press molding to form a light weight, stiff, relatively homogeneous article.

The core 30 has a cambered airfoil shape which generally follows the shape of the airfoil 12 and is bounded by opposed concave and convex exterior surfaces 34 and 36, respectively. The core 30 comprises a low-density material such as polymeric foam. As used herein, the term “low-density” does not refer to any absolute magnitude, but rather the relative density of the core 30 compared to that of the composite layup 28. One non-limiting example of a suitable core material is an elastomeric polyurethane foam having a density of about 40% of the density of the composite layup 28.

In operation, aerodynamic forces acting on the airfoil 12 induce bending moments that tend to “decamber” the airfoil 12. The stiffness of the airfoil 12 resists bending deflections. When the core 30 is present without modification, its stiffness (i.e. Young's modulus) is generally much lower than the stiffness of the surrounding composite layup 28. This results in high interlaminar shear stresses at the interface between the core 30 and the composite layup, which are likely to initiate delamination in the composite layup under operating conditions. The stiffness of the core 30 can be increased, but at the expense of increasing its density, which would be detrimental to the purpose of employing the core 30 for weight reduction.

To increase the effective stiffness of the core 30 without significantly increasing its density, reinforcing fibers 38 (seen in FIG. 3) are stitched through the core 30 and through at least part of the composite layup 28. The fibers 38 may be formed using any fiber with a high tensile strength. In the illustrated example, the fibers 38 comprise tows of intermediate modulus carbon fiber, similar to the fibers used to manufacture the tapes described above. Another example of a suitable material is carbon nanofiber.

The fibers 38 are configured in a continuous pattern including transverse fibers 40 extending transverse to the core exterior surfaces 34 and 36, (i.e. in a through-thickness direction), interconnected by loops 42 extending parallel to the core exterior surfaces 34 and 36. The fibers 38 may be configured as a series of side-by-side rows (one row 44 is depicted in front of another row 46 in FIG. 3), or in another two-dimensional or three-dimensional pattern. The fibers 38 may be stitched using an ultrasonic needle apparatus.

The transverse fibers 40 extend through the core 30 and through at least a portion of the thickness of the composite layup 28. The stitching can be done at a foam subcomponent level, in which case opposed “facesheets” 48 and 50 of composite material are first secured by the fibers 38 to the core outer surfaces 34 and 36. The subassembly would then be ready to assemble to the remainder of the airfoil 12. Alternatively, the fibers 38 may be stitched through the composite layup 28 and the core 30 with the core 30 already assembled into the uncured composite layup 28.

When cured, the stitched fibers 38 add shear, compressive, and tensile strength to an otherwise low density, low strength material. In addition, the stitching increases the core's stiffness to decrease peak stresses in the composite caused by the core geometry. Optimization of the spacing between transverse fibers 40 (i.e. stitch pattern density) may be based on bulk analysis and/or coupon level testing.

The direction of the transverse fibers 40 relative to the outer surfaces 34 and 36 of the core 30 may be selected so as to provide the maximum shear loading capability at the carbon/foam interface. In the illustrated example, the transverse fibers 40 are oriented with an angle a of approximately 45 degrees from perpendicular to the exterior surfaces 34 and 36.

The stitching (whether done at the core subassembly or airfoil assembly level) may be applied in a dry condition, with no composite resin used. The entire airfoil 12 may be then be cured using a known autoclave process. During the cure, resin from the matrix of the composite layup 28 is free to wick along the fibers 38, and cure in place, incorporating the fibers 38 as part of the cured structure.

The reinforcing structure and process described herein enables the use of low-density foam in a composite airfoil. This process adds strength and decreases stress concentrations with the minimum amount of weight. It is an enabler for low density foam application in fan blades. This has a ripple effect into disk, case, and attachment hardware. Being able to use this foam will provide a technical advantage over solid composites.

The foregoing has described a reinforced composite structure. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation, the invention being defined by the claims.

What is claimed is:

1. A composite structure, comprising:
a core having a pair of opposed exterior surfaces and having a first density;
a composite layup surrounding the core, the composite layup comprising a plurality of layers of fibers embedded in a matrix and extending along the exterior surfaces of the core, the composite layup having a second density; and
stitching comprising fibers extending through the core and at least a portion of the composite layup.

2. The structure of claim 1 wherein stitching is configured in a continuous pattern including transverse fibers extending through the core and at least a portion of the composite layup, the transverse fibers interconnected by loops extending generally parallel to the core exterior surfaces.

3. The structure of claim 1 wherein the stitching is configured as a series of side-by-side rows.

4. The structure of claim 1 wherein the transverse fibers are oriented at an acute angle relative to a direction perpendicular to one of the exterior surfaces of the core.

5. The structure of claim 1 wherein the transverse fibers are oriented at an angle of about 45 degrees relative to a direction perpendicular to one of the exterior surfaces of the core.

6. The structure of claim 1 wherein the second density is substantially greater than the first density.

7. The structure of claim 1 wherein the first density is about 40 percent of the second density.

8. The structure of claim 1 wherein the stitching comprises carbon tows.

9. The structure of claim 1 wherein the composite layup comprises carbon fibers and an epoxy matrix.

10. The structure of claim 1 wherein the core comprises elastomeric foam.

11. The structure of claim 1 wherein the core comprises polyurethane foam.

12. A fan blade comprising the composite structure of claim 1 wherein the composite layup is configured in an airfoil shape having a leading edge, a trailing edge, a root, a tip, and opposed pressure and suction sides extending between the leading and trailing edges.

13. A method of making a composite structure, comprising:
stitching fibers through both of:
a core that includes a pair of opposed exterior surfaces, wherein the core has a first density; and
at least a portion of a composite layup that surrounds the core, the composite layup comprising a plurality of layers of fibers extending along the exterior surfaces of the core, the fibers embedded in an uncured resin matrix, wherein the composite layup has a second density; and
simultaneously curing the core, the composite layup, and the fibers.

14. The method of claim 13 further comprising:
stitching the fibers through both of:
the core; and
a pair of facesheets that constitute a portion of the composite layup, each facesheet extending along one of the exterior surfaces of the core, each facesheet comprising at least one layer of fibers embedded in an uncured resin matrix;
placing the remainder of the composite layup in position surrounding the facesheets and the core; and
simultaneously curing the core, the facesheets, the composite layup, and the fibers.

15. The method of claim 13 wherein the stitching is configured in a continuous pattern including transverse fibers extending through the core and at least a portion of the composite layup, the transverse fibers interconnected by loops extending generally parallel to the core exterior surfaces.

16. The method of claim 13 wherein the stitching is configured as a series of side-by-side rows.

17. The method of claim 13 wherein the transverse fibers are oriented at an acute angle relative to a direction perpendicular to one of the exterior surfaces of the core.

18. The method of claim 13 wherein the transverse fibers are oriented at an angle of about 45 degrees relative to a direction perpendicular to one of the exterior surfaces of the core.

19. The method of claim 13 wherein the second density is substantially greater than the first density.

20. The method of claim 13 wherein the first density is about 40 percent of the second density.

21. The method of claim 13 wherein the stitching comprises carbon tows.

22. The method of claim 13 wherein the composite layup comprises carbon fibers and an epoxy matrix.

23. The method of claim 13 wherein the core comprises elastomeric foam.

24. The method of claim 13 wherein the core comprises polyurethane foam.

25. The method of claim 13 wherein the composite layup is configured in an airfoil shape having a leading edge, a trailing edge, a root, a tip, and opposed pressure and suction sides extending between the leading and trailing edges.
